(19) United States
(12) Patent Application Publication
(10) Pub. No.: US 2005/0081385 A1
(43) Pub. Date: Apr. 21, 2005

(54) Multipurpose spoon structure

(76) Inventor: Chen-Lung Ho, Tao-Yuan Hsien (TW)

Correspondence Address: Chen-Lung Ho, P. O. Box No. 6-57, Junghe, Taipei, 235, TW

(21) Appl. No.: 10/685,388

(22) Filed: Oct. 16, 2003

(51) Int. Cl. A47J 43/28

(52) U.S. Cl. 30/123; 30/324; 30/325; 30/326

(57) ABSTRACT

The invention herein relates to a multipurpose spoon structure, including a spoon, a flow-stopper and a springy element, wherein, one end of the spoon is a bowl-shaped part with a water outlet therein; at the other end is a handle holding a hanger hereunder used to hang the spoon to the rim of a pot. Moreover, the handle of spoon and the mobile handle of flow-stopper pegged together at a specific place is encompassed with a springy element, whereby enabling the flow-stopper to move up and down on the spoon, making a valve held at one end of the flow-stopper covering up the water outlet. When pressing a trigger, the valve subsequently lifts up, thus opening the water outlet. When being released, the trigger is sprung back in place by the strength of the springy element, and the valve go down and cover up the water outlet.

### BACKGROUNG OF THE INVENTION

a) Field of the Invention

The invention herein relates to a multipurpose spoon structure, more specifically to a spoon with applications such as ladling out soup, fishing out pieces, removing oil from a soup, separating an egg's white from yolk, sifting out and filtering elements of different sizes, straining juice and so on. Thereby, the invention really improves the practical value of a spoon and also adds some economical benefit.

b) Description of the Prior Art

The structure of conventional serving spoons mainly consists in a bowl-shaped part, the bottom whereof being level or concave. Such a spoon can serve as an eating utensil for soup, or else be used to ladle out pieces or remove the floating oil residue when cooking the soup. But, there are drawbacks such as: fished out pieces will come out with some floating oil, thereby making the beautifully tasting pieces look oily and thus not as appetizing as it should be; or else, when removing the floating oil, some soup will be removed as well and when trying to slowly pour the soup back in the pot, it will be very hard to avoid pouring some oil as well, only after several inefficient pouring back will you be able to remove most part of the floating oil residue but then quite a few tasty soup would have been lost in the process.

Skimmer is another type of spoon, the bottom of the bowl-shaped part whereof is riddled with several water outlets. Such a spoon is reserved for ladling out food pieces while the soup runs back to the pot through the water outlets. But, with this type of spoon, it's impossible to remove the floating oil residue and the pieces will be brought out with the oil floating on the soup, thus making tasty food looks greasy and unappetizing.

As described above, whatever the spoon type, serving or skimmer, it can only perform one function, which severely reduce their practical value and bring no economical benefit.

Thus, given every disadvantage of conventional spoons, the inventors haven't spared any efforts to overcome them, while combining all their strong points. Therefore adding many years of industrial experience and skills to research, they invented a multipurpose spoon structure more practical, with extensive functions and granted with professional practical value.

### SUMMARY OF THE INVENTION

The invention consists in a spoon, a flow-stopper and a springy element, of which: the spoon, one end whereof is a bowl-shaped part with a water outlet therein; with an external hinge at a specific place on an handle hereof and flow-stopper pegged on; the handle also holding a hanger hereunder that for hanging the spoon to a rim of a pot. The flow-stopper, located on top of the spoon, with a mobile handle holding an internal hinge pegged at a specific place thereon in order to fit exactly with the external hinge of the handle; one end of the mobile handle acting as a valve to cover the water outlet of the bowl-shaped part of the spoon; while the other end being a trigger whereon the user can press. And, the springy element, stuck in between the spoon and the flow-stopper at the junction of both hinges enables the flow-stopper to move up and down on the spoon.

The primary objective of the invention is to provide a multipurpose spoon capable of ladling out soup, fishing out pieces, removing oil from a soup, separating an egg's white from the yolk, sifting out and filtering elements of different sizes, straining juice and many more functions. These purposes are achieved by means of an axis stuck into a springy element, pegged on the handles of both spoon and flow stopper, which keep the valve of the flow-stopper covering the water outlet of the spoon, the handle of the flow-stopper when pressed down will make the valve lift up and open the water outlet. Meanwhile, when released, the trigger is sprung back in place by the strength of the springy element; the valve can then go down and cover back the water outlet.

A second objective of the invention is to provide easiness of assembling and dismantling, by applying both hinges of spoon and flow-stopper.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a perspective assembled drawing of the invention herein;

FIG. 2 is a perspective exploded drawing of the invention herein;

FIG. 3 is an illustrative drawing of the invention in ladling out soup and fishing out pieces;

FIG. 4 is an illustrative drawing of the invention in ladling out soup;

FIG. 5 is an illustrative drawing of the invention in fishing out pieces;

FIG. 6A is an illustrative drawing of the invention in discarding floating oil (1);

FIG. 6B is an illustrative drawing of the invention in discarding floating oil (2);

FIG. 6C is an illustrative drawing of the invention in discarding floating oil (3);

FIG. 7A is an illustrative drawing of the invention in separating an egg's white from the yolk (1);

FIG. 7B is an illustrative drawing of the invention in separating an egg's white from the yolk (2);

FIG. 8 is an illustrative drawing of the invention in sifting out and filtering pieces of different sizes;

FIG. 9 is an illustrative drawing of the invention in straining juice.

### DETAILED DESCRIPTION OF THE PREFERRED EMBODIMENTS

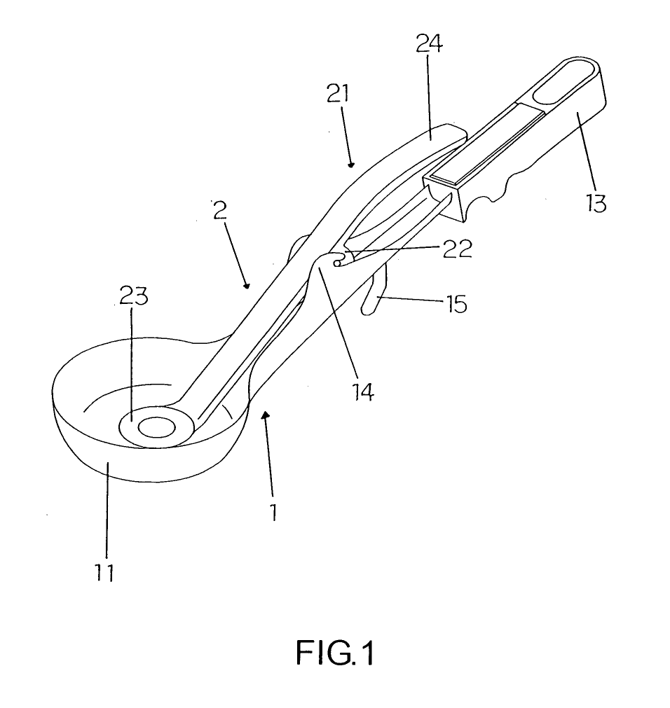

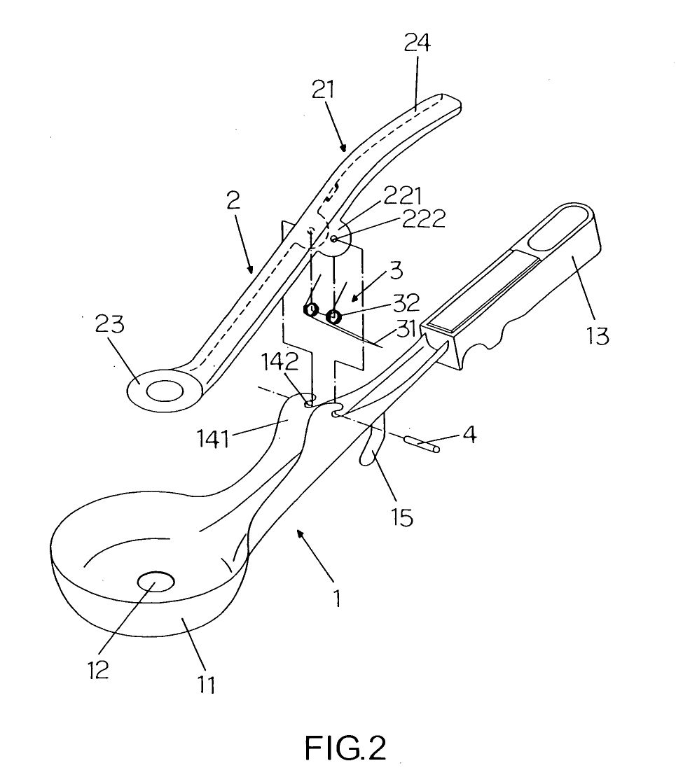

Referring to FIG. 1 and FIG. 2 the invention herein mainly consists of a spoon 1, a flow-stopper 2 and a springy element 3.

One end of the spoon 1 is a bowl-shaped part 11 with a water outlet 12 therein. The other end is a handle 13, at a specific place whereon is an external hinge 14 and flow-stopper 2 pegged on. Moreover, the handle 13 holds a hanger hereunder that is used for hanging the spoon 1 to the rim of a pot.

The flow-stopper 2 is located on top of the spoon 1. A mobile handle 21 of the flow-stopper 2 holds an internal hinge 22 pegged at a specific place thereon in order to fit exactly with the external hinge 14 of the handle 13. At one end of the mobile handle 21, a valve 23 thereon serves as a lid for the water outlet 12 of the bowl-shaped part 11 of spoon 1. At the other end of the mobile handle 21, a trigger 24 whereon can be pressed down by the user.

The springy element 3, stuck in between the spoon 1 and the flow-stopper 2 at the junction of both hinges (14, 22), enables the flow-stopper 2 to move up and down on the spoon 1.

By means of the above-mentioned combination of elements, when the trigger 24 is pressed down, the valve 23 subsequently lifts up, thus opening the water outlet 12. Meanwhile, when released, the trigger 24 is sprung back in place by the strength of the springy element 3. The valve 23 can then go down and cover up the water outlet 12. Furthermore, the invention herein can achieve several aims such as ladling out soup, fishing out pieces, removing oil from the soup, separating an egg's white from the yolk, sifting out and filtering elements of different sizes, straining juice and so on.

As described above, the bowl-shaped part 11 of the spoon 1 can also be installed with more than one water outlet 12. And, on each side of the handles (13, 21) of the spoon 1 and flow-stopper 2, both hinges (14, 22) have their own fixation hooks 141 and plates 221, facing one another. On the spoon 1, the fixation hooks 141 are opened on the top with clip holes 142, while the fixation plates 221 of the flow-stopper 2 have hinge holes 222, both pairs of holes connecting to each other. Then, a lower part of the U-shaped springy element 3 is a spring leaf 31, which, on one side, presses on a bottom of the handle 13 of the spoon 1, while the other makes a spring hole 32. The hinge holes 222 formed on the fixation plates 221 of the flow-stopper and clip holes 142 formed on the fixation hooks 141 of spoon 1 face one another. An axis 4 can then go through the clip holes 142, the hinge holes 222 and the spring holes 32, thus allowing the hinge to move.

To carry on with what was just explained, the trigger 24 of the flow-stopper 2 rests on the internal hinge 22 of the mobile handle 21. Thereby, when the trigger 24 of the flow-stopper 2 is pressed down, the springy element 3 can't spring out and the valve 23, the diameter thereof is bigger than that of the water outlet 12 of bowl-shaped part 11 of spoon 1, comes entirely covering thereon. Moreover, when the valve 23 of the flow-stopper 2 and the water outlet 12 of the bowl-shaped part 11 of spoon 1 are parted at a distance shorter than the diameter of the water outlet 12 of bowl-shaped part 1 1 of spoon 1, this distance therefore enables to sift out and filter pieces of different sizes.

When assembling the invention herein, the axis 4 is pivotedly disposed through on the flow-stopper 2 facing the clip hole 142 of the spoon, then press on the flow-stopper 2 and push thereon toward the bowl-shaped part 11 of the spoon 1, thus forcing axis 4 to be fitted in the clip hole 142 in order to finish the assembly.

When taking apart the invention herein, on the flow-stopper 2 where the hinge is, pressing thereon and pushing toward the handle 21 will make the axis 4 come out of the clip hole 142, then the flow-stopper 2 can immediately be removed in order to be cleaned.

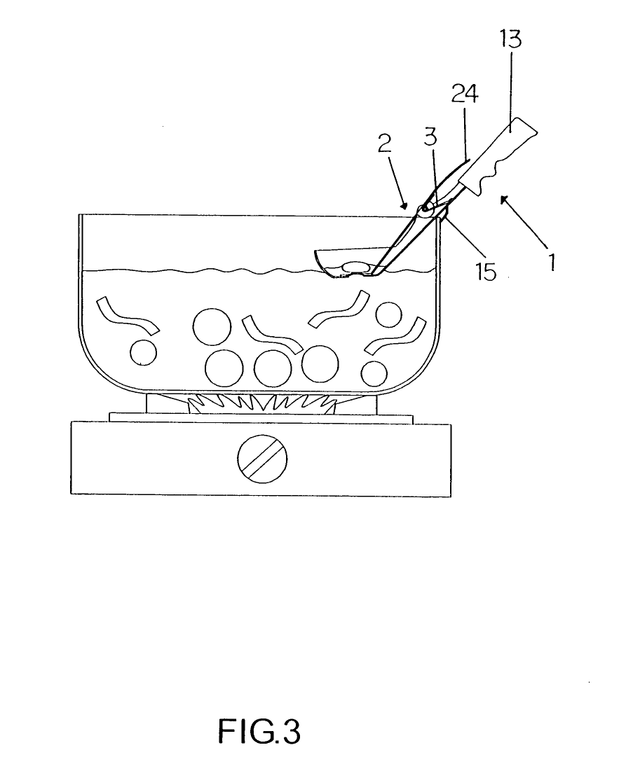

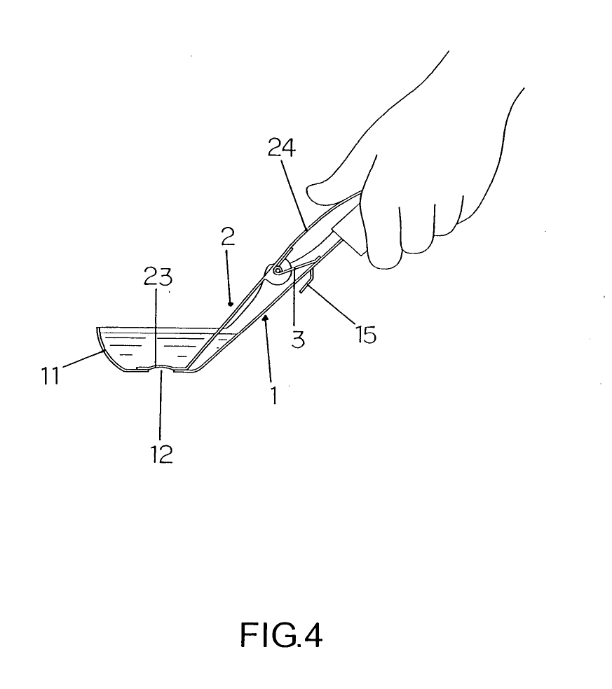

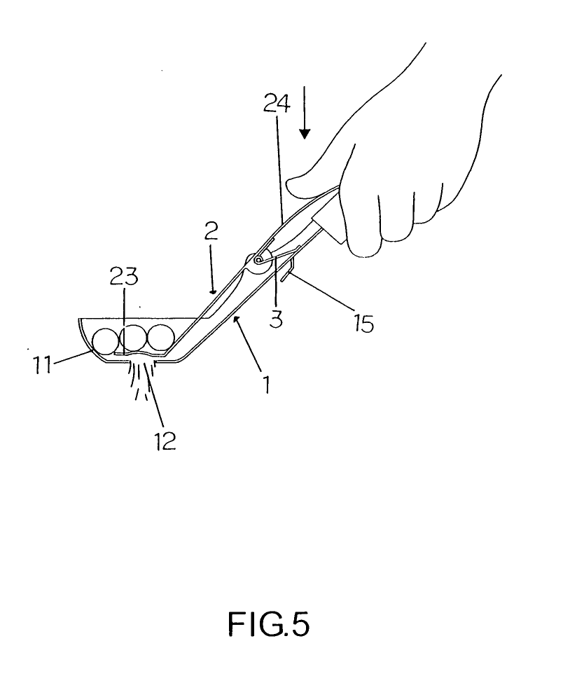

Referring to FIG. 3, the invention herein can fulfill the function of ladling out soup and pieces. When the user wants to ladle out the soup from the pot, hold tight the handle 13 of spoon 1 without pressing on the trigger 24 of flow-stopper 2, as shown on FIG. 4. When fishing out food, hold tight the handle 13 of spoon 1 and, use the thumb to press down the trigger 24 of flow-stopper 2, thus allowing the liquid from the soup to flow down back in the pot through the water outlet 12 covered by the valve 23, the user can immediately enjoy the food pieces without any juice, as shown on FIG. 5.

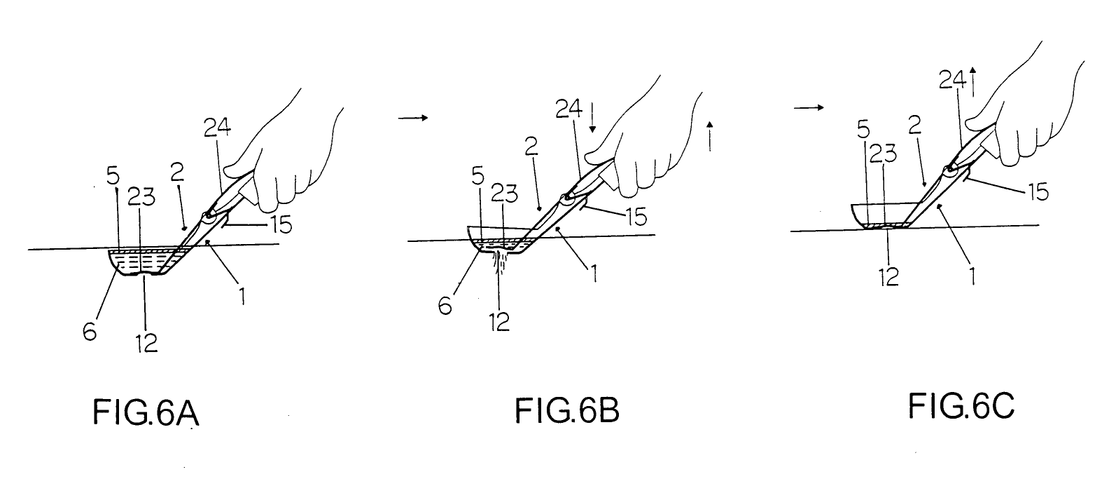

Then, referring to FIGS. 6A, 6B and 6C, the invention herein can also serve as a utensil to discard floating oil by separating the oil from the soup. In order to achieve this purpose the bowl-shaped part 11 of the spoon 1 must be placed in the soup and let the floating oil thereon flow in the spoon, until the floating oil 5 and soup 6 have filled 90% of the spoon; then press down the trigger 24 of the flow-stopper 2 in order to open the water outlet 12 whereon is the valve 23; then let the spoon 1 go up until its bottom just touch the surface of the soup. This will let the denser liquid i.e. the soup 6 to flow down back in the pot, while the liquid of lower density i.e. the floating oil 5 stays in the spoon. Next, release the trigger 24 of the flow-stopper 2 to close back the water outlet 12 of the spoon 1. At last, the invention in getting rid of the floating oil 5 can be performed.

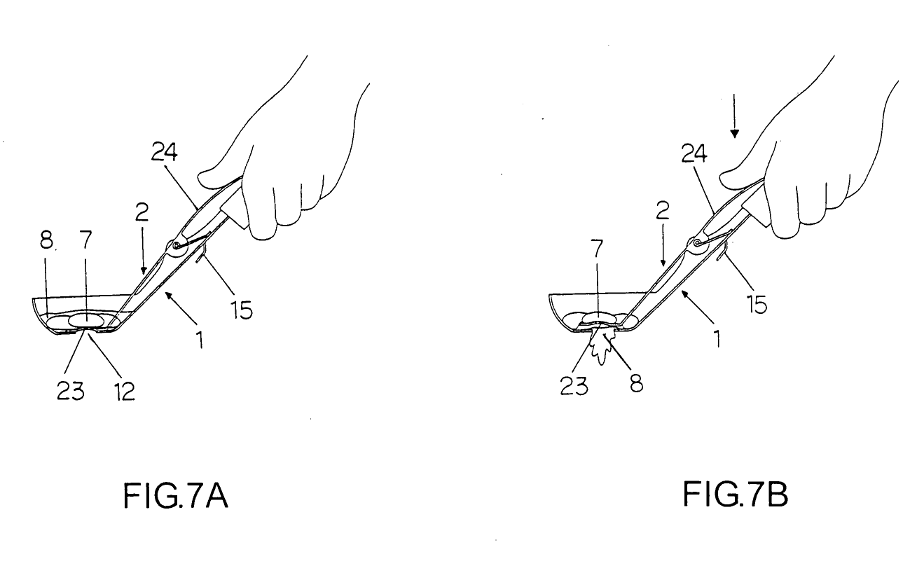

Next, referring to FIGS. 7A and 7B, another function of the invention herein is to separate an egg white 8 from yolk 7. First break an egg and put it on top of the valve 23 of the flow-stopper 2, at that time the egg white 7 will slowly stretch out inside the spoon 1. Then, hold firmly the handle 13 of spoon 1 and slightly press with the thumb the trigger 24 of flow-stopper 2 in order to open the water outlet 12 whereon is the valve 23, at that time the egg white 8 will run out through the water outlet 12, then afterwards the yolk 7 can be collected.

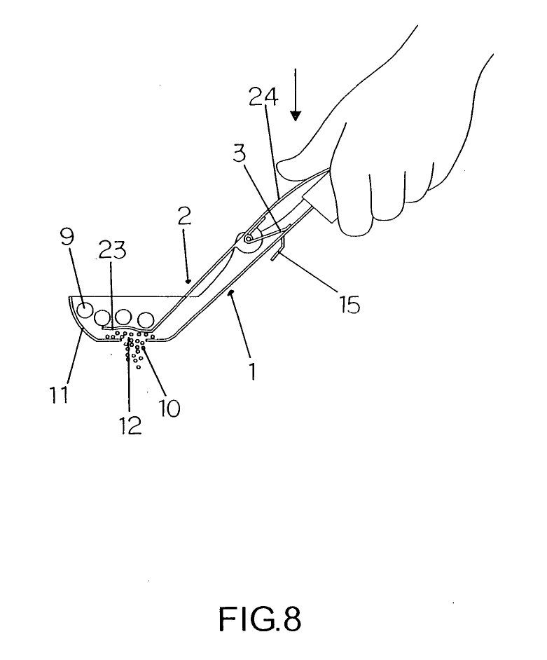

Then, referring to FIG. 8, the invention herein can act as a sifter and filter for elements of different sizes, such as soups with glutinous rice balls 9 and mung beans 10. Some eaters don't like the mung beans 10 and want to only fish out the glutinous rice balls 9, in order to achieve this, the bowl-shaped part 11 of the spoon 1 is placed in the soup, and both glutinous rice balls 9 and mung beans 10 run therein until they have filled 90% of the spoon; thereafter the trigger 24 of the flow-stopper is pressed down to open the water outlet 12 initially covered by the valve 23. At that moment, the space between the valve 23 of the flow-stopper 2 with the big glutinous rice balls 9 mixed with the small mung beans 10 thereon and the water outlet 12 opens wider, thus allowing the small mung beans to run out through the water outlet 12 while the big glutinous rice balls 9 stay on top of the valve 23. Then, the trigger 24 of the flow-stopper 2 is released to close back the water outlet 12 of the spoon 1 and the glutinous rice balls 9 can easily be collected.

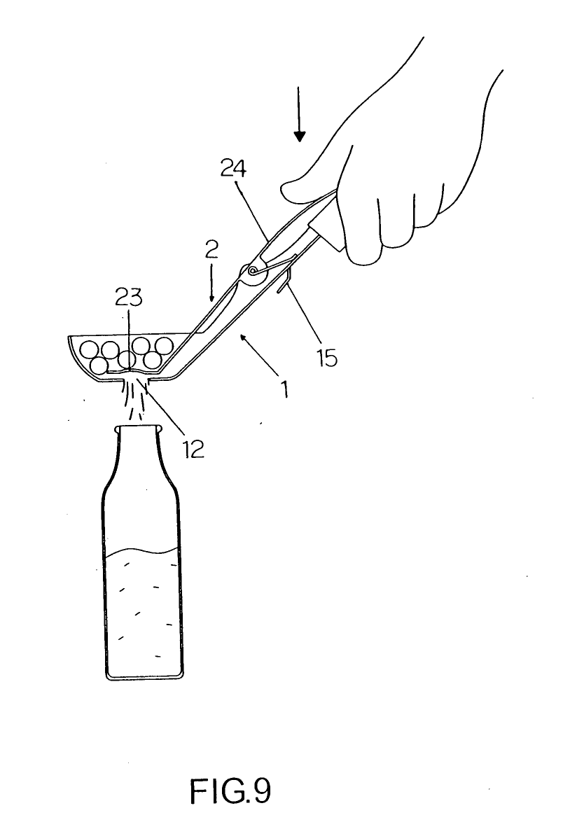

Referring to FIG. 9, one last example of an application of the invention herein is acting as a juice strainer, such as used with wine in the process of brewery. First, place the bowl-shaped part 11 of spoon 1 in the wine to collect both wine and grapes together. Then, place the water outlet 12 of the bowl-shaped part 11 of the spoon 1 exactly above the opening of a prepared bottle, then slightly press on the trigger 24 of the flow-stopper 2 in order to let open the water outlet 12 with the valve 23 covering thereon. Then, the distance between the valve 23 of the flow-stopper 2 with the big grapes thereon and the water outlet 12 will increase; thus allowing the wine to flow down through the water outlet 12 and come in the bottle through the opening of the bottle, while the grapes will stay on top of the valve 23.

It is of course to be understood that the embodiments described herein are merely illustrative of the principles of the invention and that a wide variety of modifications thereto may be effected by persons skilled in the art without departing from the spirit and scope of the invention as set forth in the following claims.

1. A multipurpose spoon structure comprising:
a spoon, one end thereof whereof is a bowl-shaped part with a water outlet therein; with an external hinge at a specific place on an handle hereof and flow-stopper pegged on; the handle also holding a hanger hereunder that for hanging the spoon to a rim of a pot;
a flow-stopper, located on top of the spoon, with a mobile handle holding an internal hinge pegged at a specific place thereon in order to fit exactly with the external hinge of the handle; one end of the mobile handle being a valve to cover the water outlet of the bowl-shaped part of the spoon; while the other end being a trigger whereon the user can press;
a springy element, stuck in between the spoon and the flow-stopper at a junction of both hinges enables the flow-stopper to move up and down on the spoon; by combination of the aforesaid elements, the trigger when pressed down will make the valve lift up and open the water outlet meanwhile, when released, the trigger is sprung back in place by the strength of the springy element; the valve can then go down and cover back the water outlet; thereby, the invention herein can achieve ladling out soup, fishing out pieces, removing oil from a soup, separating an egg's white from the yolk, sifting out and filtering elements of different sizes or else straining juice.

2. The multipurpose spoon structure according to claim 1, wherein, further including a plurality of water outlet.

3. The multipurpose spoon structure according to claim 1, wherein on each side of the handles of the spoon and flow-stopper, both hinges having their own fixation hooks and plates, facing one another; the fixation hooks on the spoon opening on a top with clip holes, while the fixation plates of the flow-stopper having hinge holes, both pairs of holes connecting to each other; a lower part of the U-shaped springy element having a spring leaf, which, on one side, pressing on a bottom of the handle of the spoon, while the other forming a spring hole; the hinge holes on the fixation plates of the flow-stopper and clip holes on the fixation hooks of spoon face one another; the axis going through the clip holes, the hinge holes and the spring holes, thus allowing the hinge to move.

4. The multipurpose spoon structure according to claim 1, wherein the trigger of the flow-stopper rests on the internal hinge of the mobile handle; to ensure the springy element not spring out when trigger is pressed down.

5. The multipurpose spoon structure according to claim 1, wherein the diameter of the valve of flow-stopper is bigger than that of the water outlet of bowl-shaped part of the spoon, thereby entirely covering up the water outlet.

6. The multipurpose spoon structure according to claim 1, wherein the valve of the flow-stopper can be parted from the water outlet of the bowl-shaped part of the spoon at a distance shorter than that of the water outlet of the flow-stopper in order to select a size of what can go through thus acting as a sifter and filter for elements of different sizes.
